(19) United States
(12) Patent Application Publication
(10) Pub. No.: US 2026/0075057 A1
(43) Pub. Date: Mar. 12, 2026

(54) Software Portal for Improving Rack Cabling in Data Centers

(71) Applicant: Oracle International Corporation, Redwood Shores, CA (US)

(72) Inventors: Zhenghong Sun, Kirkland, WA (US); Rohit Shashank Pagedar, San Jose, CA (US); James William Daniel, Issaquah, WA (US); Rajneesh Bajpai, San Jose, CA (US); Puja Sarda, Sammamish, WA (US); Benjamin Richard Anderson, Mountlake Terrace, WA (US); Rakshit Murthy Viswanatham, Charlotte, NC (US); Md Nahid Hossain, Hollis, NY (US); Montana Gorsuch, Upper Arlington, OH (US); Chintamani Lonkar, Oakland, CA (US); Qun Niu, San Mateo, CA (US)

(21) Appl. No.: 18/829,977

(22) Filed: Sep. 10, 2024

(51) Int. Cl. H04L 9/40; G06Q 10/0631

(52) U.S. Cl. CPC H04L 63/102; G06Q 10/063114

(57) ABSTRACT

In one embodiment, a method includes receiving, by a software portal and from a user of an external provider, a request for viewing cabling tasks associated with a set of one or more racks provisioned by a cloud service provider. The request is associated with a set of specified rack metadata. The method also includes searching, by the software portal, for a set of cabling tasks matching the set of specified rack metadata. Each of the cabling tasks includes respective cabling instructions for connecting racks provisioned by the cloud service provider. The method further includes verifying, by the software portal, whether the user has permissions to view each of the set of cabling tasks and, responsive to verifying that the user has the permissions to view at least a subset of the set of cabling tasks, presenting, to the user, the subset of the set of cabling tasks.

### TECHNICAL FIELD

This disclosure generally relates to rack cabling management, and more specifically to a software portal for improving rack cabling in data centers.

### BACKGROUND

A data center is a building, a dedicated space within a building, or a group of buildings used to house computer systems and associated components, such as telecommunications and storage systems. Since information technology (IT) operations are crucial for continuity, it generally includes redundant or backup components and infrastructure for power supply, data communication connections, environmental controls (e.g., air conditioning, fire suppression), and various security devices.

Rack cabling is the design and installation of a cabling system that will support multiple hardware uses and be suitable for today's needs and those of the future. With a correctly installed system, current and future requirements can be met, and hardware that is added in the future will be supported. Rack cabling design and installation is governed by a set of standards. These standards define how to lay the cabling in various topologies to meet the needs of the data center.

Traditionally, rack cabling in a data center is a manual process requiring close coordination between engineers, a data center operating team, and low voltage vendors (LVV), which are external providers working in the data center and performing rack cabling. Due to LV vendors' lack of direct access to internal systems of a cloud service provider who provisions the data center, the data center operating team may act as a middleman to interpret, translate, generate, and coordinate the required actions from the LVVs. When a new rack is installed, the data center operating team may provide printed installation instructions to the vendor. Similarly, when cable errors are detected during the cable validation phase, human coordination with LVVs is needed to resolve it. These manual processes result in the following issues. One issue includes delays for LVVs to start work, which increases overall capacity delivery time. As LVVs depend on data center operators to check the status of work performed for cabling and cable issue resolution, they cannot quickly address cable problems. This not only results in rack ingestion delays, but also makes resolution time unpredictable as troubleshooting can carry over across LVV shifts, requiring context loading. Generating and tracking the LVV effectiveness metrics may become difficult or impossible due to lack of end-to-end automation for cabling work.

### BRIEF DESCRIPTION OF THE DRAWINGS

FIG. 1 illustrates a diagram for integrating a software portal with a capacity ingestion workflow and with a rack validation workflow, according to at least one embodiment.

FIG. 2 illustrates a system architecture for enabling the software portal for rack cabling, according to at least one embodiment.

FIG. 3 illustrates a diagram for accessing the software portal for rack cabling, according to at least one embodiment.

FIG. 4 illustrates a diagram for creating a project, according to at least one embodiment.

FIG. 5A illustrates a diagram for obtaining projects and cabling work status, according to at least one embodiment.

FIG. 5B illustrates a diagram for obtaining a cut sheet and updating cabling work status, according to at least one embodiment.

FIG. 6 illustrates a diagram for obtaining cable validation results and instructions to fix issues, and marking fix as complete, according to at least one embodiment.

FIG. 7A illustrates a home page of the software portal, according to at least one embodiment.

FIG. 7B illustrates a rack details page of the software portal, according to at least one embodiment.

FIGS. 8A-8B illustrate a method for using a software portal to improve the completion of rack cabling tasks, according to at least one embodiment.

FIG. 9 is a block diagram illustrating an example pattern of an IaaS architecture, according to at least one embodiment.

FIG. 10 is a block diagram illustrating another example pattern of an IaaS architecture, according to at least one embodiment.

FIG. 11 is a block diagram illustrating another example pattern of an IaaS architecture, according to at least one embodiment.

FIG. 12 is a block diagram illustrating another example pattern of an IaaS architecture, according to at least one embodiment.

FIG. 13 illustrates an example computer system, in which various embodiments may be implemented.

### DESCRIPTION OF EXAMPLE EMBODIMENTS

### Overview

According to an embodiment, one or more computer-readable non-transitory storage media may embody software executable for the following operations. The operations may include receiving, by a software portal from a user of an external provider, a request for viewing cabling tasks associated with a set of one or more racks provisioned by a cloud service provider. The request may be associated with a set of specified rack metadata. The operations may also include searching, by the software portal, a plurality of cabling tasks for a set of cabling tasks matching the set of specified rack metadata. Each of the plurality of cabling tasks may include respective cabling instructions for connecting a plurality of racks provisioned by the cloud service provider. The operations may additionally include verifying, by the software portal, whether the user has permissions to view each of the set of cabling tasks. The operations may further include responsive to verifying that the user has the permissions to view at least a subset of the set of cabling tasks, presenting the subset of the set of cabling tasks by the software portal to the user.

In certain embodiments, the request may be accompanied by a user principal associated with the user. Accordingly, verifying whether the user has permissions to view each of the set of cabling tasks may be based at least on the user principal. In one embodiment, the user principal may be granted to the user based on authentication of the user by an identity provider (IdP) of the cloud service provider.

In certain embodiments, a user account for the user of the external provider may be within a tenancy managed by the cloud service provider. Authentication of the user to the user account may be performed by an identity provider (IdP) of the cloud service provider. In one embodiment, a user account for a second user of the cloud service provider may be within a second tenancy managed by the cloud service provider. A user account for a second user of a second external provider may be within the same tenancy managed by the cloud service provider. In one embodiment, an access policy that provides permissions for accessing cabling tasks may be scoped to user accounts within a specified tenancy.

In certain embodiments, the software portal may include a front end and a back end. Receiving the request may be performed by the front end of the software portal. Searching the plurality of cabling tasks for the set of cabling tasks and verifying whether the user has the permissions may be performed by the back end of the software portal. In one embodiment, the front end and the back end may be within different virtual cloud networks of a same tenancy.

In certain embodiments, the operations may further include receiving, by the software portal from the user of the external provider, a second request for a set of one or more cut sheets associated with a specified rack. The operations may additionally include verifying, by the software portal, whether the user has permissions to view each of the set of cut sheets. Responsive to verifying that the user has the permissions to view at least a subset of the set of cut sheets, the operations may further include presenting, by the software portal to the user, the subset of the set of cut sheets. In one embodiment, the set of cabling tasks and the set of cut sheets may be obtained from different data sources.

In certain embodiments, the operations may further include receiving, by the software portal from the user of the external provider, a second request to update a status corresponding to a first cabling task of the set of cabling tasks. Based on the second request, the operations may further include updating the status corresponding to the first cabling task.

In certain embodiments, the plurality of cabling tasks may include at least one of wiring tasks generated by one or more users of the cloud service provider and validating tasks generated based on validation activity executed by a rack deployment and validation service. In one embodiment, execution of the validation activity may be triggered responsive to detecting resolution of a wiring task of the plurality of cabling tasks.

In certain embodiments, the software portal may include a graphical user interface (GUI). The GUI may be configured to display an overview the subset of the set of cabling tasks. The GUI may be further configured to display details of each of the subset of the set of cabling tasks upon receiving a user selection of each of the subset of the set of cabling tasks. The GUI may be operable for the user of the external provider to update a status associated with each of the subset of the set of cabling tasks.

In certain embodiments, the external provider may include a low voltage vendor (LVV).

In certain embodiments, searching the plurality of cabling tasks for the set of cabling tasks may include identifying respective rack metadata associated with each of the plurality of cabling tasks, determining whether the respective rack metadata matches the set of specified rack metadata, and identifying the set of cabling tasks associated with the respective rack metadata that matches the set of specified rack metadata.

According to another embodiment, a system may include one or more processors and a non-transitory memory coupled to the processors comprising instructions, when executed by the processors, cause the processors to execute the following operations. The operations may include receiving, by a software portal from a user of an external provider, a request for viewing cabling tasks associated with a set of one or more racks provisioned by a cloud service provider. The request may be associated with a set of specified rack metadata. The operations may also include searching, by the software portal, a plurality of cabling tasks for a set of cabling tasks matching the set of specified rack metadata. Each of the plurality of cabling tasks may include respective cabling instructions for connecting a plurality of racks provisioned by the cloud service provider. The operations may additionally include verifying, by the software portal, whether the user has permissions to view each of the set of cabling tasks. The operations may further include responsive to verifying that the user has the permissions to view at least a subset of the set of cabling tasks, presenting the subset of the set of cabling tasks by the software portal to the user.

According to yet another embodiment, a method may include receiving, by a software portal from a user of an external provider, a request for viewing cabling tasks associated with a set of one or more racks provisioned by a cloud service provider. The request may be associated with a set of specified rack metadata. The method may also include searching, by the software portal, a plurality of cabling tasks for a set of cabling tasks matching the set of specified rack metadata. Each of the plurality of cabling tasks may include respective cabling instructions for connecting a plurality of racks provisioned by the cloud service provider. The method may additionally include verifying, by the software portal, whether the user has permissions to view each of the set of cabling tasks. The method may further include responsive to verifying that the user has the permissions to view at least a subset of the set of cabling tasks, presenting the subset of the set of cabling tasks by the software portal to the user.

Technical advantages of certain embodiments of this disclosure may include one or more of the following. The disclosed systems and methods can improve security and privacy as each LVV vendor will have their own login ID and their access will adhere to security and privacy requirements. In certain embodiments, the data associate with the rack cabling projects adheres to data retention policy. The disclosed system and method may provide a mechanism to achieve a one-click download of a cut sheet for labeling and inter-rack cabling work. The disclosed systems and methods can effectively provide additional information to assist with cabling such as building floor plan, a rack power up sequence, and instructions. The disclosed systems and methods can allow the LVV vendor to filter the work items based on site, project, rack, etc., which ensures that the site supervisor and lead technicians can select and assign the work at the appropriate granularity. The disclosed systems and methods may allow the LVV vendors to track the status of a rack cabling work.

Other technical advantages will be readily apparent to one skilled in the art from the following figures, descriptions, and claims. Moreover, while specific advantages have been enumerated above, various embodiments may include all, some, or none of the enumerated advantages.

### Example Embodiments

The embodiments disclosed herein relate to a software portal via which external providers can access necessary information for completing rack cabling tasks in a data center associated with a cloud service provider. The information may include assigned work-items, cut sheets, building floor plans, rack power up sequences, instructions, and status of rack validation progress. The software portal may be integrated with internal systems of the cloud service provider to allow external providers to access necessary information without going through a middleman of the cloud service provider. As used herein, the term “middleman” refers to an internal user of the cloud service provider dedicated to interpreting, translating, generating, and coordinating cabling tasks for external providers. The software portal may be auto-integrated with the internal systems for external access of the rack cabling information. In particular embodiments, an external provider may first sign into the software portal via a sign-on user-interface (UI) page, during which the external provider is authenticated and authorized based on the sign-on credentials. The external provider may be mapped to a predefined user with specified permissions, which helps isolate internal systems from direct access by the external provider. The specified permissions may allow the external provider to only access information that is required for performing their assigned cabling task. The external provider can report the cabling status back to the internal systems via the software portal. The internal systems may then run cable validation. If errors related to the cabling are detected, the software portal may translate the errors to interpretable language and provide the translated errors to the external provider so that they can correct the errors. The internal systems may re-validate the fixed cabling. Although this disclosure describes a particular portal for particular cabling tasks in particular manners, this disclosure contemplates any suitable portal for any suitable cabling task in any suitable manner.

To remove the need for the data center operating team to act as a middleman for cabling, reduce the per-rack cable error resolution time, and eliminate cross-shift handover of work items, the embodiments disclosed herein build a dedicated rack cabling software portal to deliver cabling instruction sets, cabling correctness feedback, and the ability to self-service cabling validation directly to LVVs. The software portal may be fully integrated with capacity ingestion workflows relevant to LVV workstreams. Through the software portal, LVVs can view assigned work-items, check the status of a rack's validation progress, and capture and report back the progress of their work.

The software portal may be integrated with cut-sheet generation, automatic rack validation and graphics processing unit (GPU) cable validation workflows using software plugins. This ensures that the software portal does not need to change when capacity ingestion workflow, validation tests or UI rendering changes.

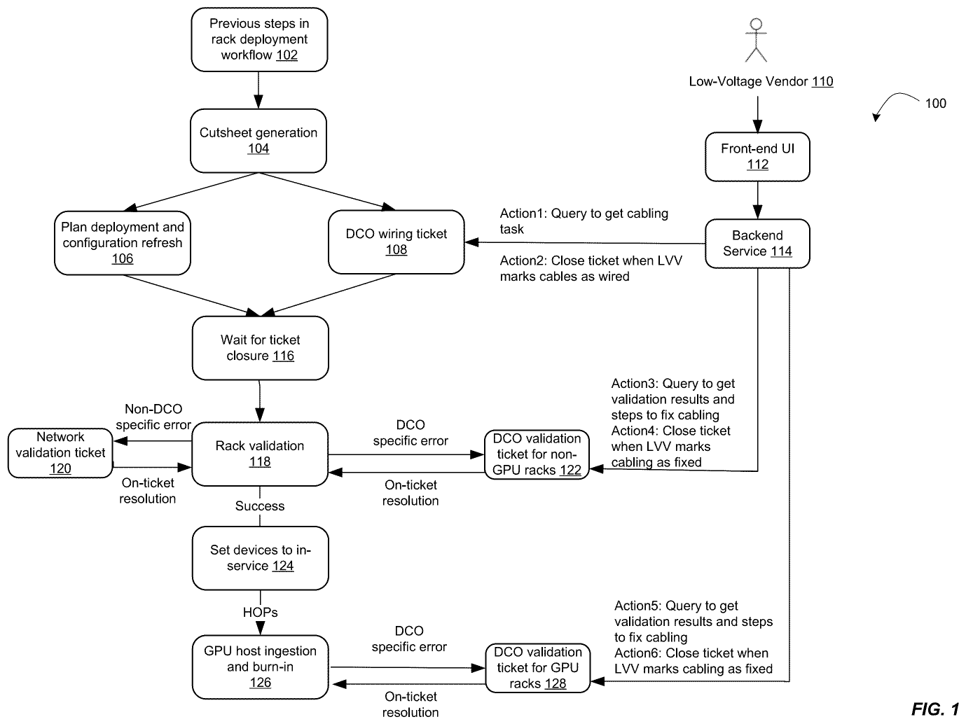

FIG. 1 illustrates a diagram 100 for integrating the software portal with a capacity ingestion workflow and with a rack validation workflow, according to at least one embodiment. The capacity ingestion workflow may include actions 1-2 and the rack validation workflow may include actions 3-6.

Within the rack deployment workflow, places that require human intervention with low-voltage vendors may include the wiring ticket from the data center operating team, a normal rack validation ticket, and a GPU validation ticket. Conventionally, the data center operating team may be responsible for obtaining status/results from these tickets and conveying this information to low-voltage vendors. Once the low-voltage vendors complete their tasks, they report back, and the data center operating team may resolve the associated tickets. The resolution of these tickets may be automatically detected, followed by subsequent steps.

The software portal may directly interface with low-voltage vendors and these tickets, mirroring the actions performed by the data operating team. As illustrated in the diagram 100, when LLVs seek cabling instructions via the software portal, the software portal may query Jira and other internal services to provide the necessary instructions. Subsequently, when low-voltage vendors update the cabling status to “complete” through the software portal, the software portal may automatically resolve the corresponding Jira tickets on their behalf. This streamlined process may eliminate the need for back-and-forth communication between the data center operating team and low-voltage vendors, as LLVs may interact directly with the software portal.

Referring to FIG. 1, based on previous steps in rack deployment workflow 102, the rack ingestion flow may perform cut sheet generation 104. A cut sheet (e.g., a data sheet, specification sheet, or technical data sheet) may contain connectivity information of network devices across racks. A cut sheet may be generated from the rack stock-keeping unit (SKU)/type, location, and/or network layout. The rack ingestion flow may then perform plan deployment and configuration refresh 106. The rack ingestion flow may also generate data center operating (DCO) ticket 108.

An LLV 110 may access a front-end UI 112 of the software portal, which further accesses a backend service 114 of the software portal. At action 1 of FIG. 1, the backend service 114 may perform an action of querying a ticketing tool to obtain a cabling task from the DCO wiring ticket 108. The ticketing tool may be an issue-tracking and management web application used to document strategic roadmaps, projects, and work assignments. At action 2, the backend service 114 may additionally perform an action of closing the ticket when LVV 110 marks cables as wired.

The rack ingestion flow may wait for ticket closure 116 and then perform rack validation 118. In particular embodiments, the rack ingestion flow may skip validation if all devices are in service. If the validation fails with a non-DCO specific error, the rack ingestion flow may generate a network validation ticket 120 resulted from network cable validation, which may return on-ticket resolution to rack validation 118. If the validation fails with a DCO specific error, the rack ingestion flow may generate a DCO validation ticket for non-GPU racks 122.

At action 3, the LVV 110 may use the front-end UI 112, via the backend service 114, to query the ticketing tool to obtain validation results and steps to fix cabling from the DCO validation ticket 122. At action 4, the LVV 110 may then use the front-end UI 112, via the backend service 114, to close the ticket when they mark the cabling as fixed. The DCO validation ticket 122 may then return the on-ticket resolution to rack validation 118.

If the validation is successful, the rack ingestion flow may set devices to in-service 124. The rack ingestion flow may then use a host provisioning service (HOPs) to perform GPU host ingestion and burn-in 126. If there is DCO specific error, the rack ingestion flow may generate a DCO validation ticket for GPU racks 128.

At action 5, the LVV 110 may use the front-end UI 112, via the backend service 114, to query the ticketing tool to obtain validation results and steps to fix cabling from the DCO validation ticket 128. At action 6, the LVV 110 may then use the front-end UI 112, via the backend service 114, to close the ticket when they mark cabling as fixed. The DCO validation ticket 128 may then return the on-ticket resolution to GPU host ingestion and burn-in 126.

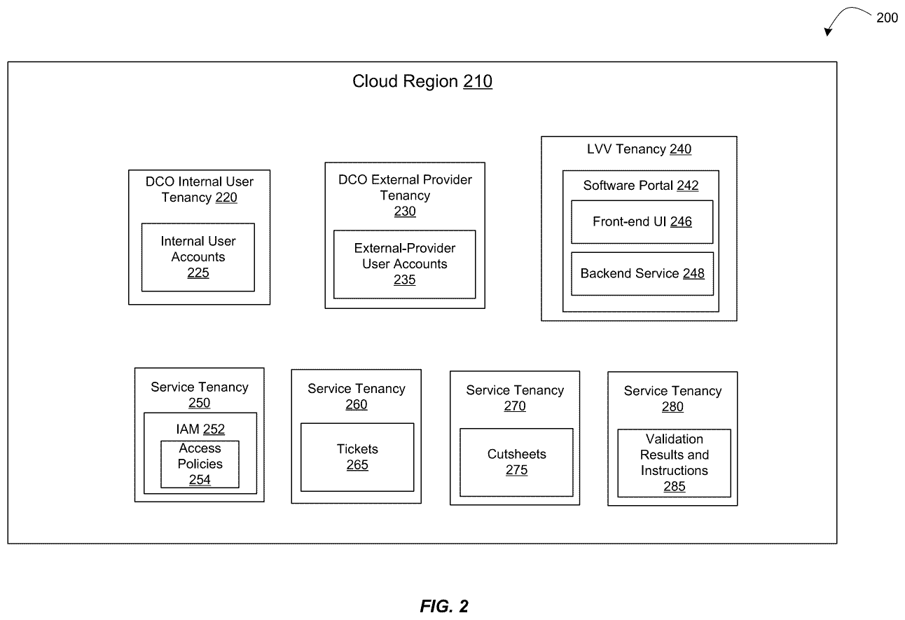

FIG. 2 illustrates a system architecture 200 for enabling the software portal for rack cabling, according to at least one embodiment. In particular embodiments, a cloud region 210 may be associated with the cloud service provider. It should be noted that although this disclosure describes one cloud region in FIG. 2, any suitable number (e.g., more than one) of cloud regions can be associated with the cloud service provider.

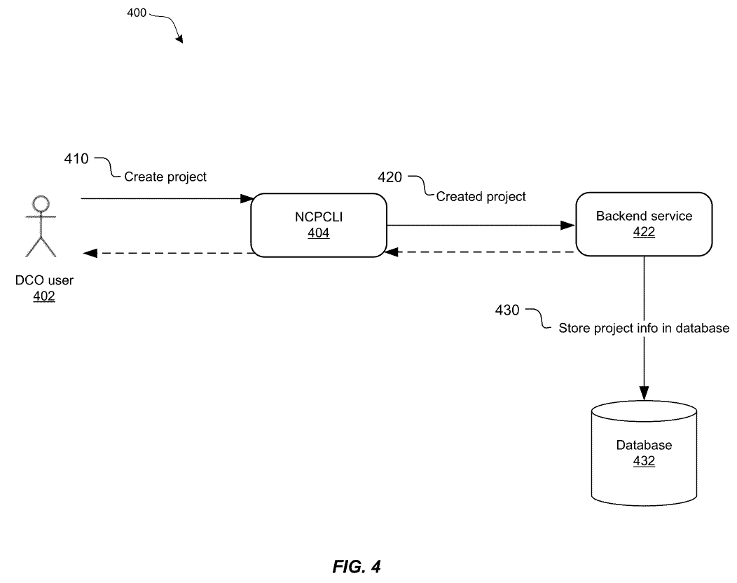

The cloud region 210 may include a DCO internal user tenancy 220, which includes internal user accounts 225. The DCO internal user tenancy 220 may be set up for internal users of the data center operating team for creating and managing cabling projects using their internal user accounts 225. It should be noted that although this disclosure describes one DCO internal user tenancy in a cloud region in FIG. 2, any suitable number of DCO internal user tenancies can be within a cloud region. Examples of operations for creating cabling tasks and assigning them to external providers are described herein with reference to FIG. 4.

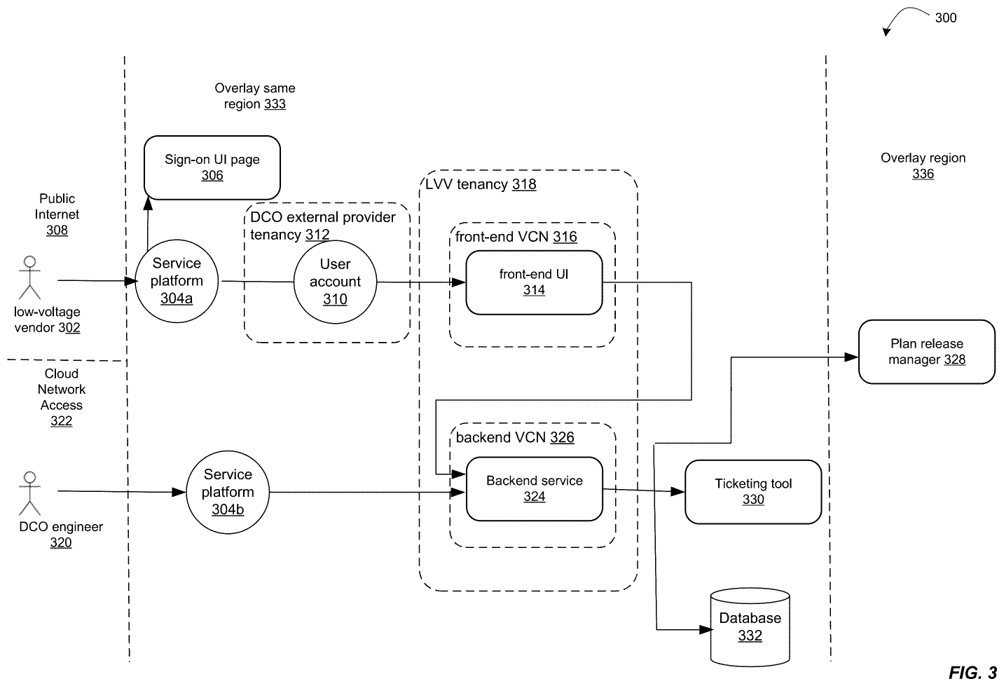

The cloud region 210 may also include a DCO external provider tenancy 230, which includes external-provider user accounts 235. The DCO external provider tenancy 230 may be set up for low-voltage vendors to use their external-provider user accounts 235 to access the software portal. It should be noted that although this disclosure describes one DCO external provider tenancy in a cloud region in FIG. 2, any suitable number of DCO external provider tenancies can be within a cloud region. Examples of operations for accessing the software portal via the DCO external provider tenancy are described herein with reference to FIG. 3.

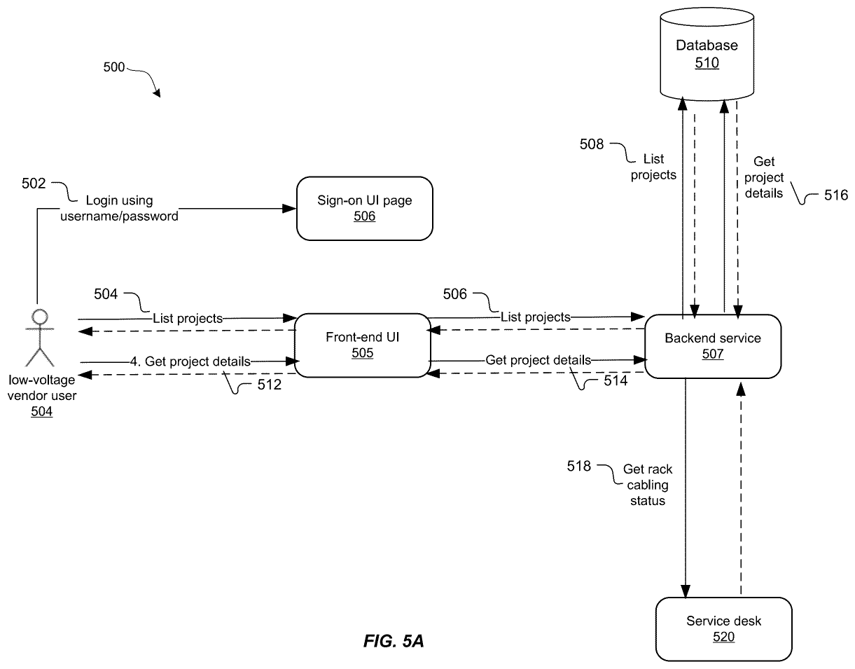

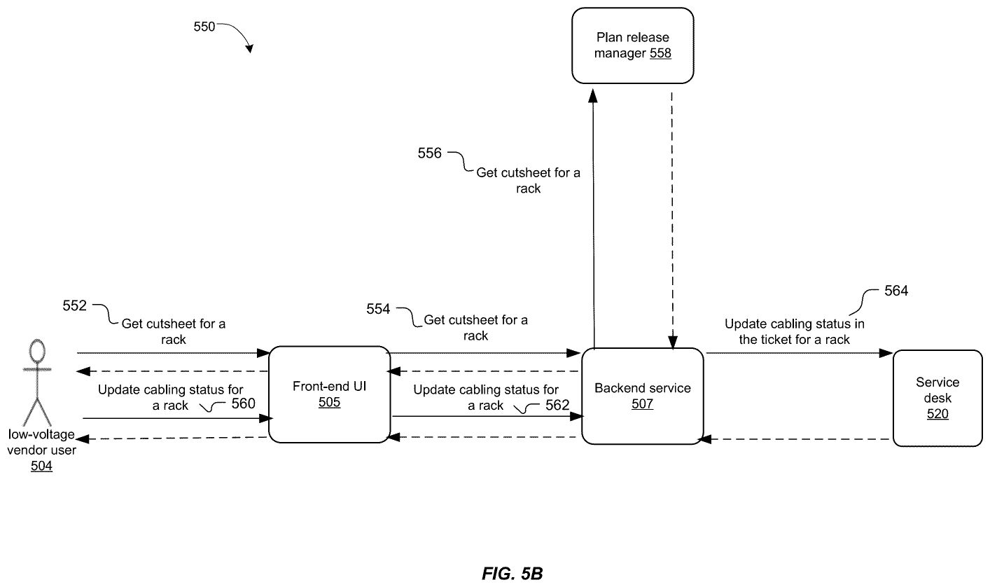

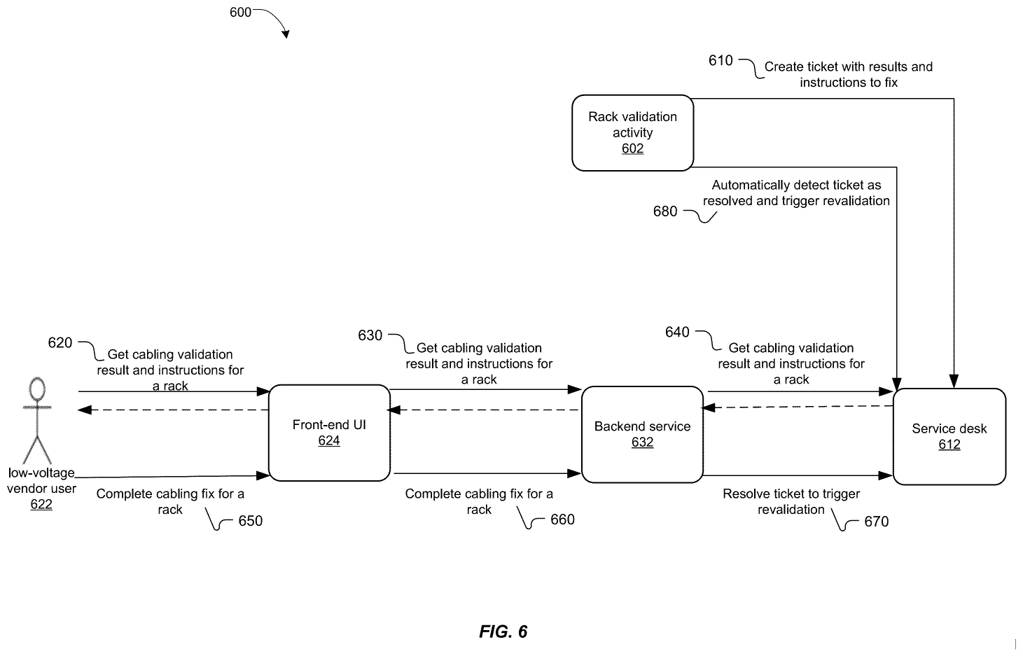

The cloud region 210 may further comprise a low-voltage vendor (LVV) tenancy 240. The LVV tenancy 240 may be a logical construct where a corresponding LVV can access cloud resources allocated to them. A low-voltage vendor may only access resources within their designated LVV tenancy. In particular embodiments, the LVV tenancy 240 may comprise the software portal 242 disclosed herein. A software portal 242 refers to software and/or hardware configured to provide cabling tasks and related internal information to external providers. Examples of operations for providing cabling tasks and related internal information to external providers are described herein with reference to FIG. 3, FIGS. 5A-5B, FIG. 6, FIGS. 7A-7B, and FIGS. 8A-8B. The software portal 242 may include a front-end UI 246 and a backend service 248. The front-end UI 246 and backend service 248 may support the functions of the software portal 242 disclosed herein. More details of the front-end UI and backend service for supporting the software portal will be described below with respect to FIG. 3, FIGS. 5A-5B, and FIG. 6.

In particular embodiments, the cloud region 210 may further comprise a plurality of service tenancies, e.g., service tenancy 250, service tenancy 260, service tenancy 270, and service tenancy 280. The service tenancy 250 may comprise identity and access management (IAM) 252. IAM 252 may control who has access to the cloud resources and what type of access users have and to which specific resources. IAM 252 may further comprise access policies 254. An access policy may comprise a document that specifies who can access which resources, and how. Access may be granted at the group and compartment level, which means a policy may give a group of users a specific type of access to the tenancy itself. Examples of operations for enabling external providers to access designated rack cabling tasks using IAM are described herein with reference to FIG. 3 and FIG. 5A.

The service tenancy 260 may comprise tickets 265. The rack cabling tasks and the completion status and validations can be communicated with the external provider as tickets 265. Examples of operations for using tickets to communicate with external providers regarding rack cabling tasks are described herein with reference to FIG. 1 and FIG. 3.

The service tenancy 270 may comprise cutsheets 275. Cutsheet 275 are provided to external providers for labeling and rack cabling tasks. Examples of operations for obtaining cutsheets by external providers are described herein with reference to FIG. 5B.

The service tenancy 280 may comprise validation results and instructions 285. Validation results and instructions 285 are provided to external providers for fixing issues of rack cabling. Examples of operations for obtaining validation results and instructions by external providers are described herein with reference to FIG. 6.

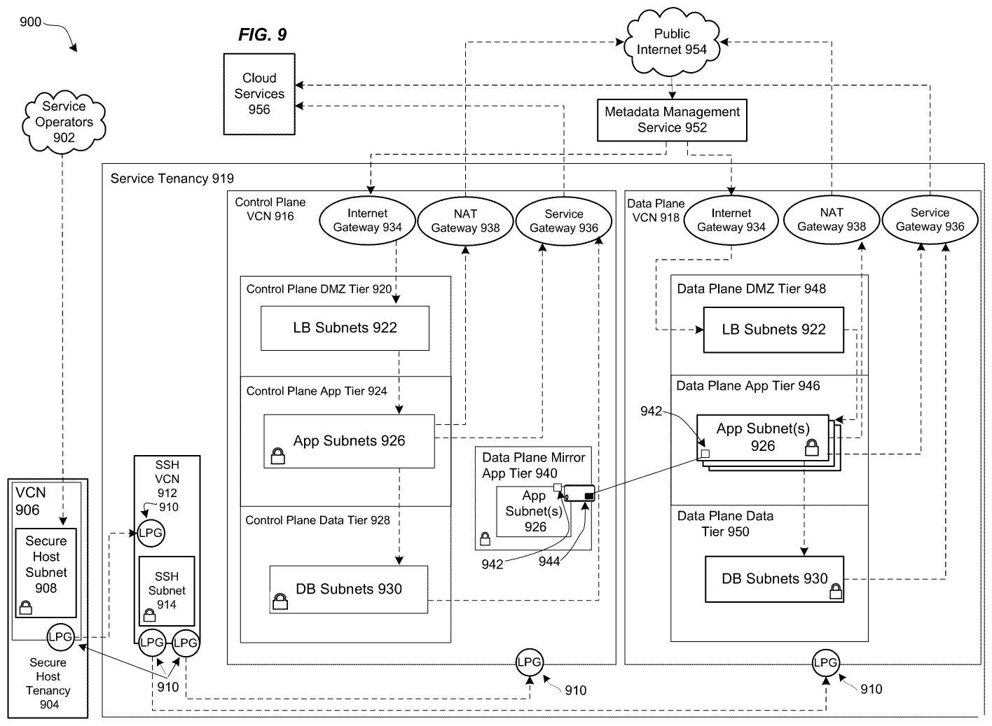

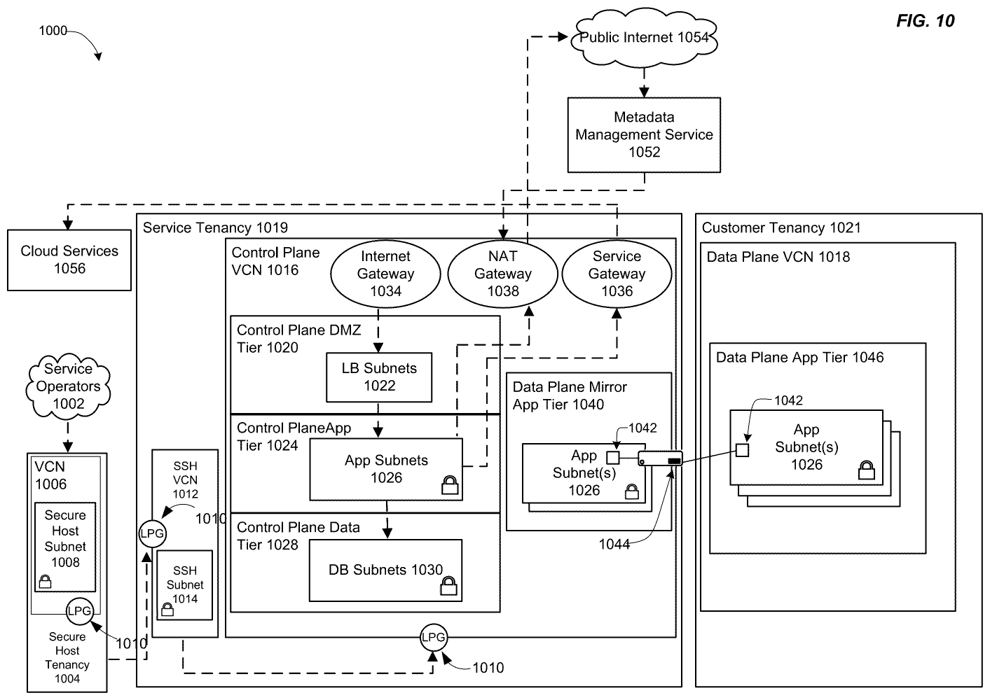

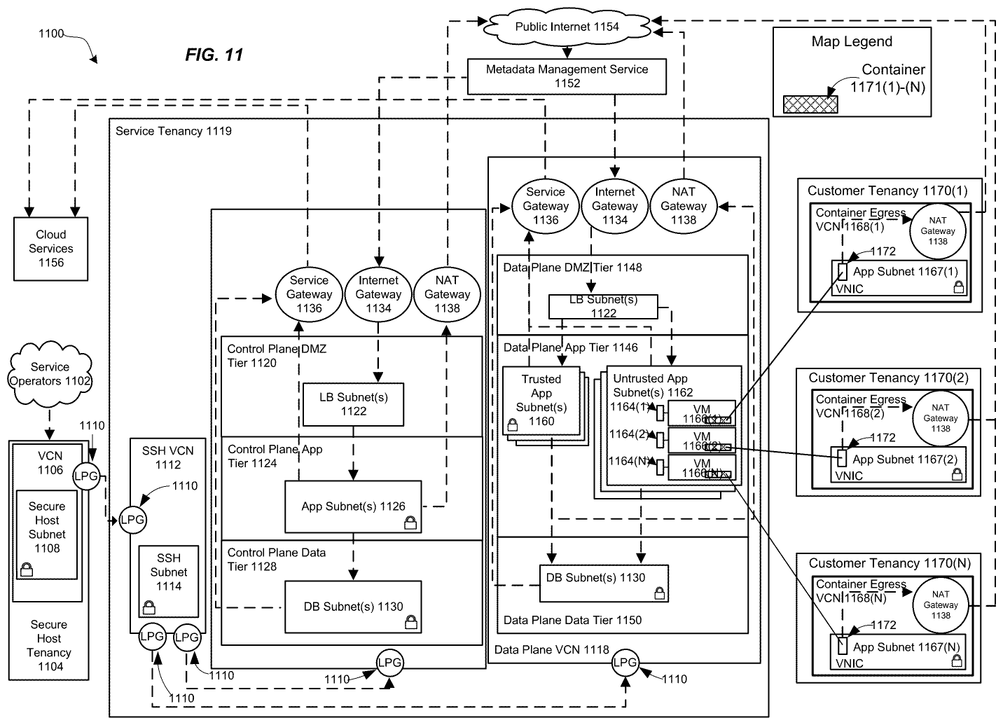

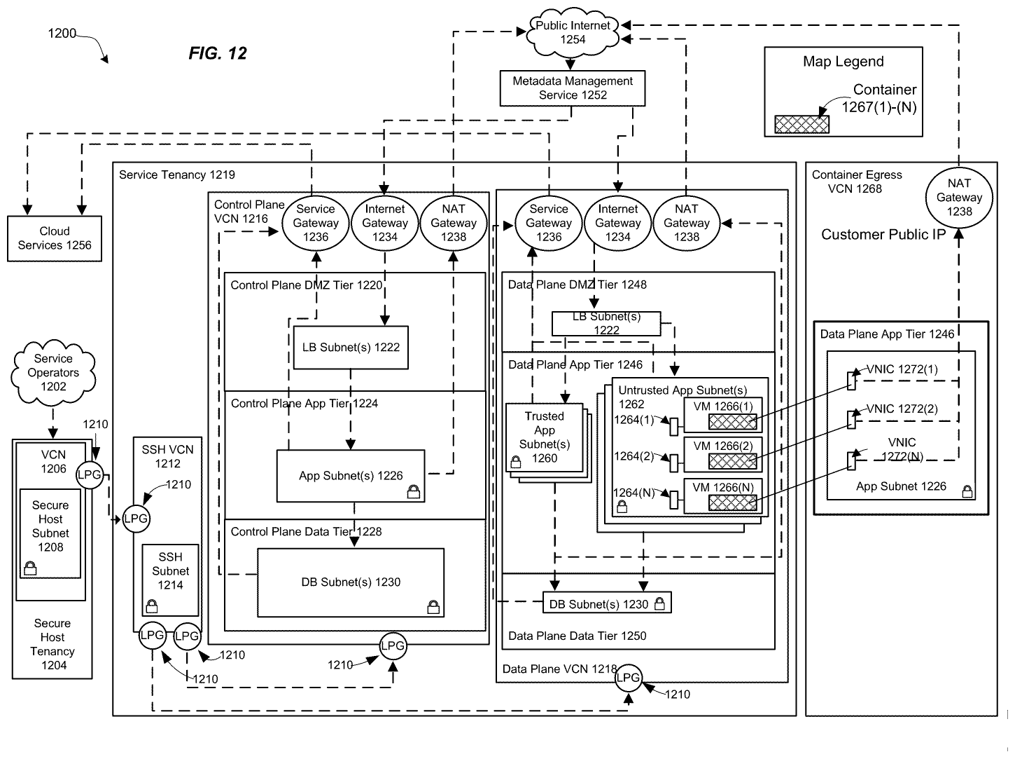

More example operations of service tenancy are described herein with reference to FIG. 9 (i.e., service tenancy 919), FIG. 10 (i.e., service tenancy 1019), FIG. 11 (i.e., service tenancy 1119), and FIG. 12 (i.e., service tenancy 1219).

FIG. 3 illustrates a diagram 300 for accessing the software portal for rack cabling, according to at least one embodiment. A low-voltage vendor 302 may access a service platform 304a via a sign-on UI page 306 of the software portal from a public Internet 308. To enable LVV to log in, the DC operating team may create a tenancy for containing one or more users associated with an LVV. In one embodiment, a single tenancy contains user accounts for multiple LVVs (or even all LVVs) of the cloud service provider. In one embodiment, only a single user account is created per LVV, such that multiple users associated with a LVV need to share the single user account corresponding to that LVV. A runbook may be created to guide the data center operating team to manage the account, including adding users when new vendors onboard and removing users when vendors are no longer valid.

A front-end UI 314 of the software portal may be supported by the service platform 304a and use the service platform's 304a authentication feature. In particular embodiments, service platform 304 may be within the service tenancy 250 described in FIG. 2 and the authentication may be based on IAM 252 as described in FIG. 2. When the low-voltage vendor 302 accesses the front-end UI 314, the service platform 304a may direct the low-voltage vendor 302 to the sign-on UI page 306. The low-voltage vendor 302 may then log in using username/password of the corresponding user account 310 assigned to them by the data center operating team (DCO). The user account 310 may be in a tenancy that is set up by the DCO, namely DCO external provider tenancy 312. The front-end UI 314 may be in a front-end virtual cloud network (VCN) 316, which is within an LVV tenancy 318. The service platform 304a and the sign-on UI page 306 may perform authentication and authorization and redirect back to the front-end UI 314 with user information. The front-end UI 314 may then identify the particular low-voltage vendor 302 corresponding to the user 310, communicate that information to the backend service 324. As a result, the backend service 324 may only query cabling tasks assigned to that particular low-voltage vendor 302.

A DCO engineer 320 having cloud network access 322 may use the service platform 304b to generate cabling tasks, which may be provided to the backend service 324 of the backend VCN 326. The front-end VCN 316 and backend VCN 326 may be within the same LVV tenancy 318. The backend service 324 may communicate the cabling tasks to the plan release manager 328, ticketing tool 330, and database 332. In particular embodiments, the architecture of the LVV tenancy 318 comprising both a front-end VCN 316 and backend VCN 326 may be designed based on the microservice architecture for the following reasons. One reason may be for security. The low-voltage vendor 302 may only interact with the front-end UI 314 of the front-end VCN 318. Therefore, only the front-end UI 314 can receive data traffic from the public internet 308 but the backend service 324 would not receive data traffic from the public internet 308. Another reason may be easy to deploy the backend service 324 to other internal users or add new services to the LVV tenancy 318.

As can be seen, the service platform 304, DCO external provider tenancy 313, LVV tenancy 318, ticketing tool 330, and database 332 may be within the overlay same region 334. The plan release manager 228 may be within another overlay region 336.

FIG. 4 illustrates a diagram 400 for creating a project, according to at least one embodiment. At step 410, a data center operating team (DCO) user 402 may use an internal tool 404, e.g., network control platform command line interface (NCPCLI) 404, to create cabling projects and assign projects to vendors. The NCPCLI 404 may be within the DCO internal user tenancy 220 where the DCO user 402 has their internal user account 225. A project can include cabling work for multiple racks, and each rack has metadata such as region, building and/or rack location. At step 420, the internal tool 404 may provide the created project to a backend service 422. At step 430, the backend service 422 may store the project information in a database 432. The database 432 may store project related information, including vendor ID, project ID, and metadata (e.g., building, block, rack, priority, etc.) related to the project.

FIG. 5A illustrates a diagram 500 for obtaining projects and cabling work status, according to at least one embodiment. At step 502, the LVV user 504 may log in using a username and password via a sign-on UI page 506.

For steps 504-508, via the front-end UI 505 and backend service 507, the LVV user 504 can list projects from the database 510. For steps 512-516, the LVV user 504 can click a project to obtain project details via the front-end UI 505 and backend service 507. At step 518, via the front-end UI 505 and backend service 507, the LVV user 504 can obtain a rack cabling status for each rack from the service desk 520 supported by a ticketing tool. For each rack within the project, the LVV user 504 may use rack details (e.g., queue, region, building, and rack location) to search tickets to find the cabling ticket and get status of each rack.

FIG. 5B illustrates a diagram 550 for obtaining a cut sheet and updating cabling work status, according to at least one embodiment. At steps 552-556, after obtaining rack details, an LVV user 504 can obtain a cut sheet for a specific rack via the front-end UI 505 of the software portal, which communicates with the backend service 507. The backend service 507 may obtain the cut sheet from a plan release manager (PRM) 558, which stores cut sheets for racks. At step 560, the LVV user 504 can update cabling status for a rack to be in-progress or completed through the front-end UI 505. At step 562, the front-end UI 505 may send the update to the backend service 507. At step 564, the backend service 507 may follow the LVV user's 504 instruction to communicate with the service desk 520 of the ticketing tool to update the cabling status in the ticket for a rack to be in-progress or resolved accordingly. For example, if the LVV user 504 starts a task from the software portal, the backend service 507 may transition the corresponding ticket to in-progress. If the LVV user 504 marks a task as completed, the backend service 507 may transition the ticket to resolved.

FIG. 6 illustrates a diagram 600 for obtaining cable validation results and instructions to fix issues, and marking fix as complete, according to at least one embodiment. A rack validation service may run validation for a rack. At step 610, based on rack validation activity 602, the rack validation service may create a ticket with validation results and instructions to fix issues and provide the ticket to the service desk 612 of the ticketing tool. If the validation tests fail, the rack validation service may further add detailed instructions into the ticket comments to guide low-voltage vendors to fix the issues.

At steps 620-640, an LVV user 622 may get cabling validation results and instructions for a rack via the front-end UI 624 of the software portal, the backend service 632, and the service desk 612. For step 640, the backend service 632 may use the ticketing queue, summary (e.g., keywords in final rack validation), rack details (e.g., region, building, rack location, etc.) to search the tickets from the service desk 612 to find the validation ticket generated. If the backend service 632 finds a ticket, that means the validation has failed, and the backend service 632 may read the ticket's description section. The ticket description section may have detailed instructions on how to fix the issues. The backend service 632 may parse these guidelines in the description section and return this guideline to the LVV user 622.

At step 650, the LVV user 622 can mark the issue to resolved with a choice of root cause via the front-end UI 624. At step 660, the front-end UI 624 may notify the backend service 632 about the completion of the cabling fix. At step 670, the backend service 632 may resolve the corresponding ticket with root cause information. At step 680, the rack validation service may detect that ticket is resolved and trigger re-validation automatically.

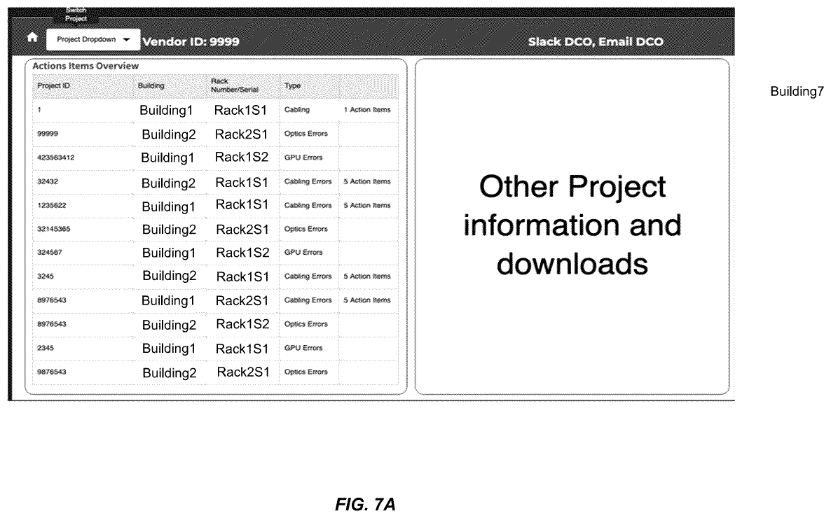

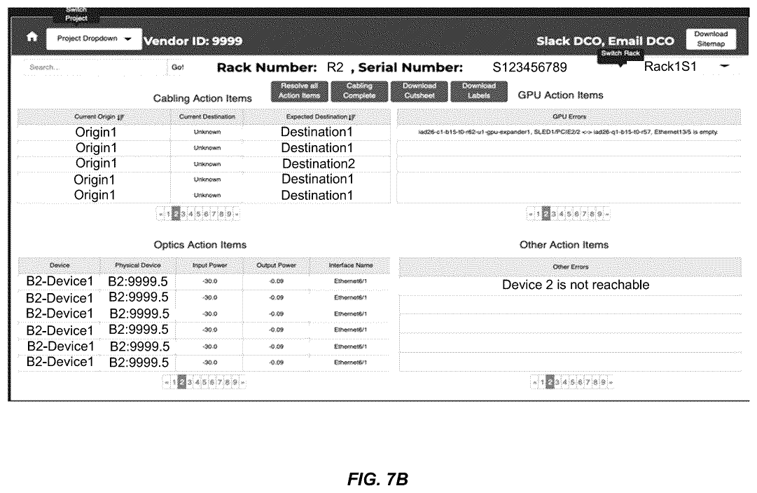

FIGS. 7A-7B illustrate a user interface of the software portal, according to at least one embodiment. FIG. 7A illustrates a home page of the software portal. After an LVV user logs into the GUI, the LLV user lands on the home page. Home page may provide a tabular overview of the work items for a given vendor, which may have filters for building, project, and/or block. From the home page, the LVV user can view the detailed work items for a given rack by clicking on the work item. FIG. 7B illustrates a rack details page of the software portal, according to at least one embodiment. Rack details page may have detailed work items related to cabling and labeling. The LVV user may be able to update the status of one or more of these work items after the LLV user competes the work item(s).

An example scenario of using the software portal for rack cabling tasks is as follows. To begin, an LVV user may log into the software portal using a mobile device or workstation at the local site, using their username and password managed by the data center operating team. Upon login, the LVV user can see a comprehensive table displaying all pending work items across various projects on their homepage. Then LVV user may then select a project from the dropdown menu based on priority. For a given project, the LVV user may then select a specific work item. For example, the specific work item is new rack cabling/wiring. Upon selecting the specific work item for a project, the LVV user may gain access to detailed information regarding the rack and essential instructions, including cut sheets, required for effective cabling. The LVV user may execute the cabling task accordingly. After completion, the LVV user may mark the work item as completed within the software portal. The software portal may progress the rack ingestion pipeline to the cabling validation step automatically. If a cabling error is to be resolved, the work item capturing cabling errors may provide the LVV user with precise error messages, pinpointing problematic links with detailed instructions to address the errors. The LVV user may fix the cabling errors as instructed. Upon resolution, the LVV user may mark the work item status as complete within the software portal. Subsequently, the software portal may initiate re-validation workflows in the background. Following task completion, the LVV user may return to the home page of the software portal to select and start working on the next prioritized item.

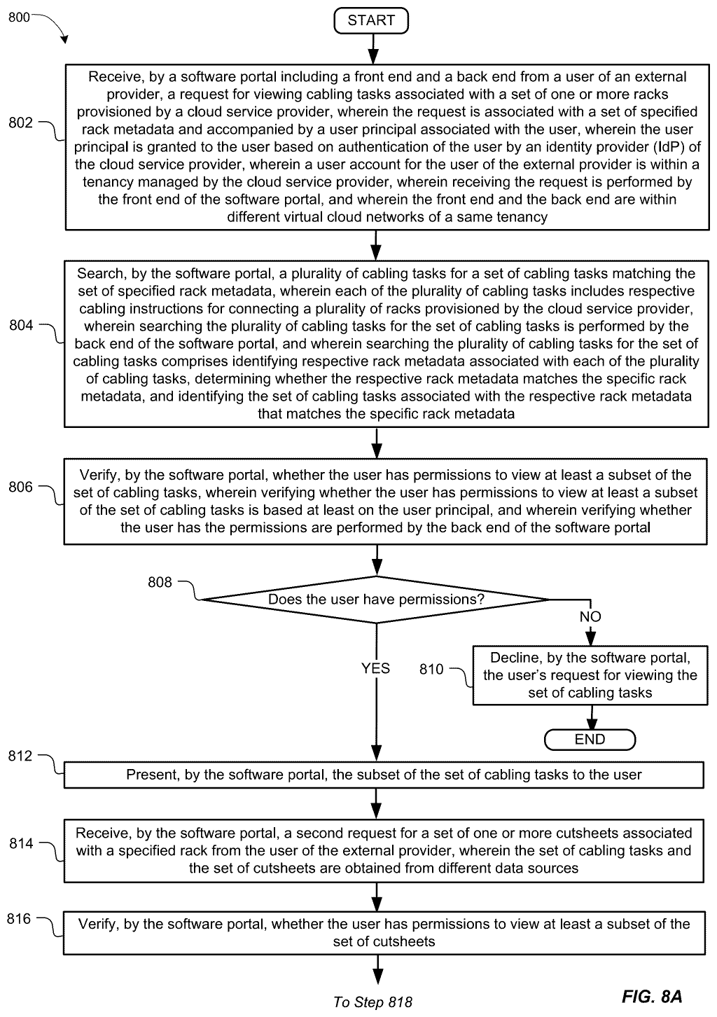

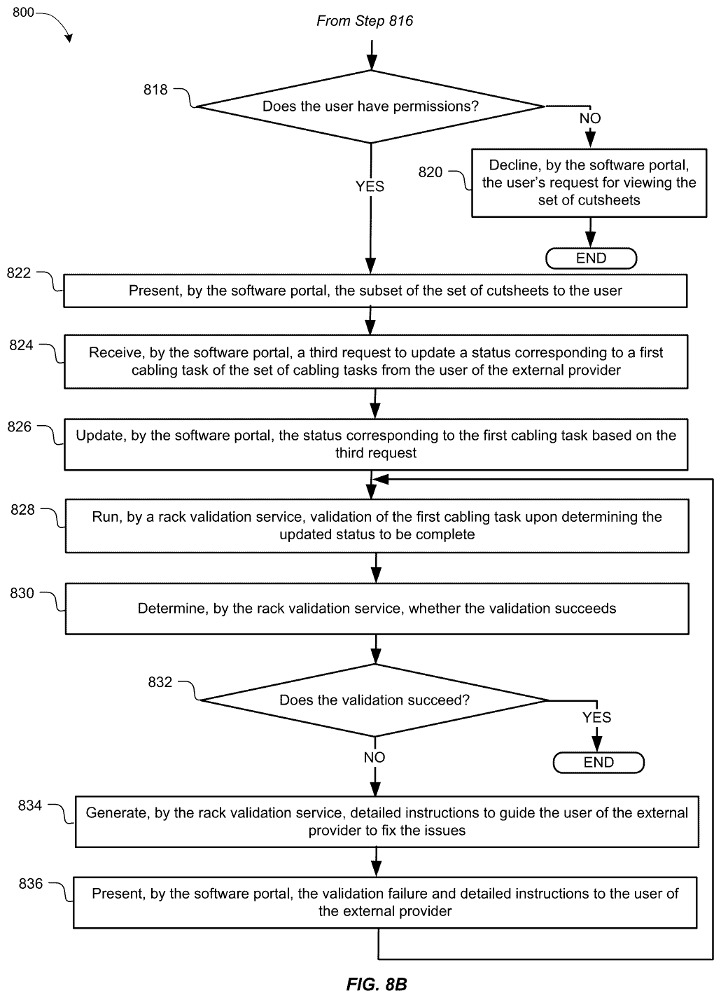

FIGS. 8A-8B illustrate a method 800 for using a software portal to improve the completion of rack cabling tasks, according to at least one embodiment. The method 800 may begin at step 802, where a software portal including a front end and a back end may receive, from a user of an external provider, a request for viewing cabling tasks associated with a set of one or more racks provisioned by a cloud service provider. The request may be associated with a set of specified rack metadata and accompanied by a user principal associated with the user. The user principal may be granted to the user based on authentication of the user by an identity provider (IdP) of the cloud service provider. A user account for the user of the external provider may be within a tenancy managed by the cloud service provider. Receiving the request is performed by the front end of the software portal. The front end and the back end are within different virtual cloud networks of a same tenancy.

At step 804, the software portal may search a plurality of cabling tasks for a set of cabling tasks matching the set of specified rack metadata. Each of the plurality of cabling tasks includes respective cabling instructions for connecting a plurality of racks provisioned by the cloud service provider. Searching the plurality of cabling tasks for the set of cabling tasks is performed by the back end of the software portal. Searching the plurality of cabling tasks for the set of cabling tasks includes identifying respective rack metadata associated with each of the plurality of cabling tasks, determining whether the respective rack metadata matches the specific rack metadata, and/or identifying the set of cabling tasks associated with the respective rack metadata that matches the specific rack metadata.

At step 806, the software portal may verify whether the user has permissions to view at least a subset of the set of cabling tasks. Verifying whether the user has permissions to view at least a subset of the set of cabling tasks is based at least on the user principal. Verifying whether the user has the permissions are performed by the back end of the software portal.

At decision point 808, if the user does not have permissions to view at least a subset of the set of cabling tasks, method 800 proceeds to step 810. At step 810, the software portal may decline the user's request for viewing the set of cabling tasks. Method 800 then ends. If, at decision point 808, the user has permissions to view at least a subset of the set of cabling tasks, method 800 proceeds to step 812. At step 812, the software portal may present the subset of the set of cabling tasks to the user.

At step 814, the software portal may receive a second request for a set of one or more cut sheets associated with a specified rack from the user of the external provider. The set of cabling tasks and the set of cut sheets are obtained from different data sources. At step 816, the software portal may verify whether the user has permissions to view at least a subset of the set of cut sheets. At decision point 818, if the user does not have permissions to view at least a subset of the set of cut sheets, method 800 proceeds to step 820. At step 820, the software portal may decline the user's request for viewing the set of cut sheets. Method 800 then ends. If, at decision point 818, the user has permissions to view at least a subset of the set of cut sheets, method 800 proceeds to step 822. At step 822, the software portal may present the subset of the set of cut sheets to the user.

At step 824, the software portal may receive a third request to update a status corresponding to a first cabling task of the set of cabling tasks from the user of the external provider. At step 826, the software portal may update the status corresponding to the first cabling task based on the third request. At step 828, a rack validation service may run validation of the first cabling task upon determining the updated status to be complete. At step 830, the rack validation service may determine whether the validation succeeds. At decision point 832, if the validation succeeds, method 800 ends. If, at decision point 832, the validation fails, method 800 proceeds to step 834, where the rack validation service may generate detailed instructions to guide the user of the external provider to fix the issues. At step 836, the software portal may present the validation failure and detailed instructions to the user of the external provider. Method 800 may repeat step 828 to step 836 until validation succeeds.

Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for using a software portal to improve the completion of rack cabling tasks including the particular steps of the method of FIG. 8, this disclosure contemplates any suitable method for using a software portal to improve the completion of rack cabling tasks including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combination of any suitable components, devices, or systems carrying out any suitable steps of the method of FIG. 8.

The embodiments disclosed herein may be utilized in infrastructure as a service (IaaS). Infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 9 is a block diagram 900 illustrating an example pattern of an IaaS architecture, according to at least one embodiment. Service operators 902 can be communicatively coupled to a secure host tenancy 904 that can include a VCN 906 and a secure host subnet 908. In some examples, the service operators 902 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 906 and/or the Internet.

The VCN 906 can include a local peering gateway (LPG) 910 that can be communicatively coupled to a secure shell (SSH) VCN 912 via an LPG 910 contained in the SSH VCN 912. The SSH VCN 912 can include an SSH subnet 914, and the SSH VCN 912 can be communicatively coupled to a control plane VCN 916 via the LPG 910 contained in the control plane VCN 916. Also, the SSH VCN 912 can be communicatively coupled to a data plane VCN 918 via an LPG 910. The control plane VCN 916 and the data plane VCN 918 can be contained in a service tenancy 919 that can be owned and/or operated by the IaaS provider.

The control plane VCN 916 can include a control plane demilitarized zone (DMZ) tier 920 that acts as a perimeter network (e.g., portions of a corporate network between the corporate intranet and external networks). The DMZ-based servers may have restricted responsibilities and help keep breaches contained. Additionally, the DMZ tier 920 can include one or more load balancer (LB) subnet(s) 922, a control plane app tier 924 that can include app subnet(s) 926, a control plane data tier 928 that can include database (DB) subnet(s) 930 (e.g., frontend DB subnet(s) and/or backend DB subnet(s)). The LB subnet(s) 922 contained in the control plane DMZ tier 920 can be communicatively coupled to the app subnet(s) 926 contained in the control plane app tier 924 and an Internet gateway 934 that can be contained in the control plane VCN 916, and the app subnet(s) 926 can be communicatively coupled to the DB subnet(s) 930 contained in the control plane data tier 928 and a service gateway 936 and a network address translation (NAT) gateway 938. The control plane VCN 616 can include the service gateway 936 and the NAT gateway 938.

The control plane VCN 916 can include a data plane mirror app tier 940 that can include app subnet(s) 926. The app subnet(s) 926 contained in the data plane mirror app tier 940 can include a virtual network interface controller (VNIC) 942 that can execute a compute instance 944. The compute instance 944 can communicatively couple the app subnet(s) 926 of the data plane mirror app tier 940 to app subnet(s) 926 that can be contained in a data plane app tier 946.

The data plane VCN 918 can include the data plane app tier 946, a data plane DMZ tier 948, and a data plane data tier 950. The data plane DMZ tier 948 can include LB subnet(s) 922 that can be communicatively coupled to the app subnet(s) 926 of the data plane app tier 946 and the Internet gateway 934 of the data plane VCN 918. The app subnet(s) 926 can be communicatively coupled to the service gateway 936 of the data plane VCN 918 and the NAT gateway 938 of the data plane VCN 918. The data plane data tier 950 can also include the DB subnet(s) 930 that can be communicatively coupled to the app subnet(s) 926 of the data plane app tier 946.

The Internet gateway 934 of the control plane VCN 916 and of the data plane VCN 918 can be communicatively coupled to a metadata management service 952 that can be communicatively coupled to public Internet 954. Public Internet 954 can be communicatively coupled to the NAT gateway 938 of the control plane VCN 916 and of the data plane VCN 918. The service gateway 936 of the control plane VCN 916 and of the data plane VCN 918 can be communicatively couple to cloud services 956.

In some examples, the service gateway 936 of the control plane VCN 916 or of the data plane VCN 918 can make application programming interface (API) calls to cloud services 956 without going through public Internet 954. The API calls to cloud services 956 from the service gateway 936 can be one-way: the service gateway 936 can make API calls to cloud services 956, and cloud services 956 can send requested data to the service gateway 936. But, cloud services 956 may not initiate API calls to the service gateway 936.

In some examples, the secure host tenancy 904 can be directly connected to the service tenancy 919, which may be otherwise isolated. The secure host subnet 908 can communicate with the SSH subnet 914 through an LPG 910 that may enable two-way communication over an otherwise isolated system. Connecting the secure host subnet 908 to the SSH subnet 914 may give the secure host subnet 908 access to other entities within the service tenancy 919.

The control plane VCN 916 may allow users of the service tenancy 919 to set up or otherwise provision desired resources. Desired resources provisioned in the control plane VCN 916 may be deployed or otherwise used in the data plane VCN 918. In some examples, the control plane VCN 916 can be isolated from the data plane VCN 918, and the data plane mirror app tier 940 of the control plane VCN 916 can communicate with the data plane app tier 946 of the data plane VCN 918 via VNICs 942 that can be contained in the data plane mirror app tier 940 and the data plane app tier 946.

In some examples, users of the system, or customers, can make requests, for example create, read, update, or delete (CRUD) operations, through public Internet 954 that can communicate the requests to the metadata management service 952. The metadata management service 952 can communicate the request to the control plane VCN 916 through the Internet gateway 934. The request can be received by the LB subnet(s) 922 contained in the control plane DMZ tier 920. The LB subnet(s) 922 may determine that the request is valid, and in response to this determination, the LB subnet(s) 922 can transmit the request to app subnet(s) 926 contained in the control plane app tier 924. If the request is validated and requires a call to public Internet 954, the call to public Internet 954 may be transmitted to the NAT gateway 938 that can make the call to public Internet 954. Metadata that may be desired to be stored by the request can be stored in the DB subnet(s) 930.

In some examples, the data plane mirror app tier 940 can facilitate direct communication between the control plane VCN 916 and the data plane VCN 918. For example, changes, updates, or other suitable modifications to configuration may be desired to be applied to the resources contained in the data plane VCN 918. Via a VNIC 942, the control plane VCN 916 can directly communicate with, and can thereby execute the changes, updates, or other suitable modifications to configuration to, resources contained in the data plane VCN 918.

In some embodiments, the control plane VCN 916 and the data plane VCN 918 can be contained in the service tenancy 919. In this case, the user, or the customer, of the system may not own or operate either the control plane VCN 916 or the data plane VCN 918. Instead, the IaaS provider may own or operate the control plane VCN 916 and the data plane VCN 918, both of which may be contained in the service tenancy 919. This embodiment can enable isolation of networks that may prevent users or customers from interacting with other users', or other customers', resources. Also, this embodiment may allow users or customers of the system to store databases privately without needing to rely on public Internet 954, which may not have a desired level of threat prevention, for storage.

In other embodiments, the LB subnet(s) 922 contained in the control plane VCN 616 can be configured to receive a signal from the service gateway 936. In this embodiment, the control plane VCN 916 and the data plane VCN 918 may be configured to be called by a customer of the IaaS provider without calling public Internet 954. Customers of the IaaS provider may desire this embodiment since database(s) that the customers use may be controlled by the IaaS provider and may be stored on the service tenancy 919, which may be isolated from public Internet 954.

FIG. 10 is a block diagram 1000 illustrating another example pattern of an IaaS architecture, according to at least one embodiment. Service operators 1002 (e.g., service operators 902 of FIG. 9) can be communicatively coupled to a secure host tenancy 1004 (e.g., the secure host tenancy 904 of FIG. 9) that can include a VCN 1006 (e.g., the VCN 906 of FIG. 9) and a secure host subnet 1008 (e.g., the secure host subnet 908 of FIG. 9). The VCN 1006 can include a local peering gateway (LPG) 1010 (e.g., the LPG 910 of FIG. 9) that can be communicatively coupled to a secure shell (SSH) VCN 1012 (e.g., the SSH VCN 912 of FIG. 9) via an LPG 910 contained in the SSH VCN 1012. The SSH VCN 1012 can include an SSH subnet 1014 (e.g., the SSH subnet 914 of FIG. 9), and the SSH VCN 1012 can be communicatively coupled to a control plane VCN 1016 (e.g., the control plane VCN 916 of FIG. 9) via an LPG 1010 contained in the control plane VCN 1016. The control plane VCN 1016 can be contained in a service tenancy 1019 (e.g., the service tenancy 919 of FIG. 9), and the data plane VCN 1018 (e.g., the data plane VCN 918 of FIG. 9) can be contained in a customer tenancy 1021 that may be owned or operated by users, or customers, of the system.

The control plane VCN 1016 can include a control plane DMZ tier 1020 (e.g., the control plane DMZ tier 920 of FIG. 9) that can include LB subnet(s) 1022 (e.g., LB subnet(s) 922 of FIG. 9), a control plane app tier 1024 (e.g., the control plane app tier 924 of FIG. 9) that can include app subnet(s) 1026 (e.g., app subnet(s) 926 of FIG. 9), a control plane data tier 1028 (e.g., the control plane data tier 928 of FIG. 9) that can include database (DB) subnet(s) 1030 (e.g., similar to DB subnet(s) 930 of FIG. 9). The LB subnet(s) 1022 contained in the control plane DMZ tier 1020 can be communicatively coupled to the app subnet(s) 1026 contained in the control plane app tier 1024 and an Internet gateway 1034 (e.g., the Internet gateway 934 of FIG. 9) that can be contained in the control plane VCN 1016, and the app subnet(s) 1026 can be communicatively coupled to the DB subnet(s) 1030 contained in the control plane data tier 1028 and a service gateway 1036 (e.g., the service gateway 936 of FIG. 9) and a network address translation (NAT) gateway 1038 (e.g., the NAT gateway 938 of FIG. 9). The control plane VCN 1016 can include the service gateway 1036 and the NAT gateway 1038.

The control plane VCN 1016 can include a data plane mirror app tier 1040 (e.g., the data plane mirror app tier 940 of FIG. 9) that can include app subnet(s) 1026. The app subnet(s) 1026 contained in the data plane mirror app tier 1040 can include a virtual network interface controller (VNIC) 1042 (e.g., the VNIC of 942) that can execute a compute instance 1044 (e.g., similar to the compute instance 944 of FIG. 9). The compute instance 1044 can facilitate communication between the app subnet(s) 1026 of the data plane mirror app tier 1040 and the app subnet(s) 1026 that can be contained in a data plane app tier 1046 (e.g., the data plane app tier 946 of FIG. 9) via the VNIC 1042 contained in the data plane mirror app tier 1040 and the VNIC 1042 contained in the data plane app tier 1046.

The Internet gateway 1034 contained in the control plane VCN 1016 can be communicatively coupled to a metadata management service 1052 (e.g., the metadata management service 952 of FIG. 9) that can be communicatively coupled to public Internet 1054 (e.g., public Internet 954 of FIG. 9). Public Internet 1054 can be communicatively coupled to the NAT gateway 1038 contained in the control plane VCN 1016. The service gateway 1036 contained in the control plane VCN 1016 can be communicatively couple to cloud services 1056 (e.g., cloud services 956 of FIG. 9).

In some examples, the data plane VCN 1018 can be contained in the customer tenancy 1021. In this case, the IaaS provider may provide the control plane VCN 1016 for each customer, and the IaaS provider may, for each customer, set up a unique compute instance 1044 that is contained in the service tenancy 1019. Each compute instance 1044 may allow communication between the control plane VCN 1016, contained in the service tenancy 1019, and the data plane VCN 1018 that is contained in the customer tenancy 1021. The compute instance 1044 may allow resources, that are provisioned in the control plane VCN 1016 that is contained in the service tenancy 1019, to be deployed or otherwise used in the data plane VCN 1018 that is contained in the customer tenancy 1021.

In other examples, the customer of the IaaS provider may have databases that live in the customer tenancy 1021. In this example, the control plane VCN 1016 can include the data plane mirror app tier 1040 that can include app subnet(s) 1026. The data plane mirror app tier 1040 can reside in the data plane VCN 1018, but the data plane mirror app tier 1040 may not live in the data plane VCN 1018. That is, the data plane mirror app tier 1040 may have access to the customer tenancy 1021, but the data plane mirror app tier 1040 may not exist in the data plane VCN 1018 or be owned or operated by the customer of the IaaS provider. The data plane mirror app tier 1040 may be configured to make calls to the data plane VCN 1018 but may not be configured to make calls to any entity contained in the control plane VCN 1016. The customer may desire to deploy or otherwise use resources in the data plane VCN 1018 that are provisioned in the control plane VCN 1016, and the data plane mirror app tier 1040 can facilitate the desired deployment, or other usage of resources, of the customer.

In some embodiments, the customer of the IaaS provider can apply filters to the data plane VCN 1018. In this embodiment, the customer can determine what the data plane VCN 1018 can access, and the customer may restrict access to public Internet 1054 from the data plane VCN 1018. The IaaS provider may not be able to apply filters or otherwise control access of the data plane VCN 1018 to any outside networks or databases. Applying filters and controls by the customer onto the data plane VCN 1018, contained in the customer tenancy 1021, can help isolate the data plane VCN 1018 from other customers and from public Internet 1054.

In some embodiments, cloud services 1056 can be called by the service gateway 1036 to access services that may not exist on public Internet 1054, on the control plane VCN 1016, or on the data plane VCN 1018. The connection between cloud services 1056 and the control plane VCN 1016 or the data plane VCN 1018 may not be live or continuous. Cloud services 1056 may exist on a different network owned or operated by the IaaS provider. Cloud services 1056 may be configured to receive calls from the service gateway 1036 and may be configured to not receive calls from public Internet 1054. Some cloud services 1056 may be isolated from other cloud services 1056, and the control plane VCN 1016 may be isolated from cloud services 1056 that may not be in the same region as the control plane VCN 1016. For example, the control plane VCN 1016 may be located in “Region 1,” and cloud service “Deployment 6,” may be located in Region 1 and in “Region 2.” If a call to Deployment 6 is made by the service gateway 1036 contained in the control plane VCN 1016 located in Region 1, the call may be transmitted to Deployment 6 in Region 1. In this example, the control plane VCN 1016, or Deployment 6 in Region 1, may not be communicatively coupled to, or otherwise in communication with, Deployment 6 in Region 2.

FIG. 11 is a block diagram 1100 illustrating another example pattern of an IaaS architecture, according to at least one embodiment. Service operators 1102 (e.g., service operators 902 of FIG. 9) can be communicatively coupled to a secure host tenancy 1104 (e.g., the secure host tenancy 904 of FIG. 9) that can include a VCN 1106 (e.g., the VCN 906 of FIG. 9) and a secure host subnet 1108 (e.g., the secure host subnet 908 of FIG. 9). The VCN 1106 can include an LPG 1110 (e.g., the LPG 910 of FIG. 9) that can be communicatively coupled to an SSH VCN 1112 (e.g., the SSH VCN 912 of FIG. 9) via an LPG 1110 contained in the SSH VCN 1112. The SSH VCN 1112 can include an SSH subnet 1114 (e.g., the SSH subnet 914 of FIG. 9), and the SSH VCN 1112 can be communicatively coupled to a control plane VCN 1116 (e.g., the control plane VCN 916 of FIG. 9) via an LPG 1110 contained in the control plane VCN 1116 and to a data plane VCN 1118 (e.g., the data plane 918 of FIG. 9) via an LPG 1110 contained in the data plane VCN 1118. The control plane VCN 1116 and the data plane VCN 1118 can be contained in a service tenancy 1119 (e.g., the service tenancy 919 of FIG. 9).

The control plane VCN 1116 can include a control plane DMZ tier 1120 (e.g., the control plane DMZ tier 920 of FIG. 9) that can include load balancer (LB) subnet(s) 1122 (e.g., LB subnet(s) 922 of FIG. 9), a control plane app tier 1124 (e.g., the control plane app tier 924 of FIG. 9) that can include app subnet(s) 1126 (e.g., similar to app subnet(s) 926 of FIG. 9), a control plane data tier 1128 (e.g., the control plane data tier 928 of FIG. 9) that can include DB subnet(s) 1130. The LB subnet(s) 1122 contained in the control plane DMZ tier 1120 can be communicatively coupled to the app subnet(s) 1126 contained in the control plane app tier 1124 and to an Internet gateway 1134 (e.g., the Internet gateway 934 of FIG. 9) that can be contained in the control plane VCN 1116, and the app subnet(s) 1126 can be communicatively coupled to the DB subnet(s) 1130 contained in the control plane data tier 1128 and to a service gateway 1136 (e.g., the service gateway of FIG. 9) and a network address translation (NAT) gateway 1138 (e.g., the NAT gateway 938 of FIG. 9). The control plane VCN 1116 can include the service gateway 1136 and the NAT gateway 1138.

The data plane VCN 1118 can include a data plane app tier 1146 (e.g., the data plane app tier 946 of FIG. 9), a data plane DMZ tier 1148 (e.g., the data plane DMZ tier 948 of FIG. 9), and a data plane data tier 1150 (e.g., the data plane data tier 950 of FIG. 9). The data plane DMZ tier 1148 can include LB subnet(s) 1122 that can be communicatively coupled to trusted app subnet(s) 1160 and untrusted app subnet(s) 1162 of the data plane app tier 1146 and the Internet gateway 1134 contained in the data plane VCN 1118. The trusted app subnet(s) 1160 can be communicatively coupled to the service gateway 1136 contained in the data plane VCN 1118, the NAT gateway 1138 contained in the data plane VCN 1118, and DB subnet(s) 1130 contained in the data plane data tier 1150. The untrusted app subnet(s) 1162 can be communicatively coupled to the service gateway 1136 contained in the data plane VCN 1118 and DB subnet(s) 1130 contained in the data plane data tier 1150. The data plane data tier 1150 can include DB subnet(s) 1130 that can be communicatively coupled to the service gateway 1136 contained in the data plane VCN 1118.

The untrusted app subnet(s) 1162 can include one or more primary VNICs 1164(1)-(N) that can be communicatively coupled to tenant virtual machines (VMs) 1166(1)-(N). Each tenant VM 1166(1)-(N) can be communicatively coupled to a respective app subnet 1167(1)-(N) that can be contained in respective container egress VCNs 1168(1)-(N) that can be contained in respective customer tenancies 1170(1)-(N). Respective secondary VNICs 1172(1)-(N) can facilitate communication between the untrusted app subnet(s) 1162 contained in the data plane VCN 1118 and the app subnet contained in the container egress VCNs 1168(1)-(N). Each container egress VCNs 1168(1)-(N) can include a NAT gateway 1138 that can be communicatively coupled to public Internet 1154 (e.g., public Internet 954 of FIG. 9).

The Internet gateway 1134 contained in the control plane VCN 1116 and contained in the data plane VCN 1118 can be communicatively coupled to a metadata management service 1152 (e.g., the metadata management system 952 of FIG. 9) that can be communicatively coupled to public Internet 1154. Public Internet 1154 can be communicatively coupled to the NAT gateway 1138 contained in the control plane VCN 1116 and contained in the data plane VCN 1118. The service gateway 1136 contained in the control plane VCN 1116 and contained in the data plane VCN 1118 can be communicatively couple to cloud services 1156.

In some embodiments, the data plane VCN 1118 can be integrated with customer tenancies 1170. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1146. Code to run the function may be executed in the VMs 1166(1)-(N), and the code may not be configured to run anywhere else on the data plane VCN 1118. Each VM 1166(1)-(N) may be connected to one customer tenancy 1170. Respective containers 1171(1)-(N) contained in the VMs 1166(1)-(N) may be configured to run the code. In this case, there can be a dual isolation (e.g., the containers 1171(1)-(N) running code, where the containers 1171(1)-(N) may be contained in at least the VM 1166(1)-(N) that are contained in the untrusted app subnet(s) 1162), which may help prevent incorrect or otherwise undesirable code from damaging the network of the IaaS provider or from damaging a network of a different customer. The containers 1171(1)-(N) may be communicatively coupled to the customer tenancy 1170 and may be configured to transmit or receive data from the customer tenancy 1170. The containers 1171(1)-(N) may not be configured to transmit or receive data from any other entity in the data plane VCN 1118. Upon completion of running the code, the IaaS provider may kill or otherwise dispose of the containers 1171(1)-(N).

In some embodiments, the trusted app subnet(s) 1160 may run code that may be owned or operated by the IaaS provider. In this embodiment, the trusted app subnet(s) 1160 may be communicatively coupled to the DB subnet(s) 1130 and be configured to execute CRUD operations in the DB subnet(s) 1130. The untrusted app subnet(s) 1162 may be communicatively coupled to the DB subnet(s) 1130, but in this embodiment, the untrusted app subnet(s) may be configured to execute read operations in the DB subnet(s) 1130. The containers 1171(1)-(N) that can be contained in the VM 1166(1)-(N) of each customer and that may run code from the customer may not be communicatively coupled with the DB subnet(s) 1130.

In other embodiments, the control plane VCN 1116 and the data plane VCN 1118 may not be directly communicatively coupled. In this embodiment, there may be no direct communication between the control plane VCN 1116 and the data plane VCN 1118. However, communication can occur indirectly through at least one method. An LPG 1110 may be established by the IaaS provider that can facilitate communication between the control plane VCN 1116 and the data plane VCN 1118. In another example, the control plane VCN 1116 or the data plane VCN 1118 can make a call to cloud services 1156 via the service gateway 1136. For example, a call to cloud services 1156 from the control plane VCN 1116 can include a request for a service that can communicate with the data plane VCN 1118.

FIG. 12 is a block diagram 1200 illustrating another example pattern of an IaaS architecture, according to at least one embodiment. Service operators 1202 (e.g., service operators 902 of FIG. 9) can be communicatively coupled to a secure host tenancy 1204 (e.g., the secure host tenancy 904 of FIG. 9) that can include a VCN 1206 (e.g., the VCN 906 of FIG. 9) and a secure host subnet 1208 (e.g., the secure host subnet 908 of FIG. 9). The VCN 1206 can include an LPG 1210 (e.g., the LPG 910 of FIG. 9) that can be communicatively coupled to an SSH VCN 1212 (e.g., the SSH VCN 912 of FIG. 9) via an LPG 1210 contained in the SSH VCN 1212. The SSH VCN 1212 can include an SSH subnet 1214 (e.g., the SSH subnet 914 of FIG. 9), and the SSH VCN 1212 can be communicatively coupled to a control plane VCN 1216 (e.g., the control plane VCN 916 of FIG. 9) via an LPG 1210 contained in the control plane VCN 1216 and to a data plane VCN 1218 (e.g., the data plane 918 of FIG. 9) via an LPG 1210 contained in the data plane VCN 1218. The control plane VCN 1219 and the data plane VCN 1218 can be contained in a service tenancy 1219 (e.g., the service tenancy 919 of FIG. 9).

The control plane VCN 1216 can include a control plane DMZ tier 1220 (e.g., the control plane DMZ tier 620 of FIG. 9) that can include LB subnet(s) 1222 (e.g., LB subnet(s) 922 of FIG. 9), a control plane app tier 1224 (e.g., the control plane app tier 924 of FIG. 9) that can include app subnet(s) 1226 (e.g., app subnet(s) 926 of FIG. 9), a control plane data tier 1228 (e.g., the control plane data tier 928 of FIG. 9) that can include DB subnet(s) 930 (e.g., DB subnet(s) 1130 of FIG. 11). The LB subnet(s) 1222 contained in the control plane DMZ tier 1220 can be communicatively coupled to the app subnet(s) 1226 contained in the control plane app tier 1224 and to an Internet gateway 1234 (e.g., the Internet gateway 934 of FIG. 9) that can be contained in the control plane VCN 1216, and the app subnet(s) 1226 can be communicatively coupled to the DB subnet(s) 1230 contained in the control plane data tier 1228 and to a service gateway 1236 (e.g., the service gateway of FIG. 9) and a network address translation (NAT) gateway 1238 (e.g., the NAT gateway 938 of FIG. 9). The control plane VCN 1216 can include the service gateway 1236 and the NAT gateway 1238.

The data plane VCN 1218 can include a data plane app tier 1246 (e.g., the data plane app tier 946 of FIG. 9), a data plane DMZ tier 1248 (e.g., the data plane DMZ tier 948 of FIG. 9), and a data plane data tier 1250 (e.g., the data plane data tier 950 of FIG. 9). The data plane DMZ tier 1248 can include LB subnet(s) 1222 that can be communicatively coupled to trusted app subnet(s) 1260 (e.g., trusted app subnet(s) 1160 of FIG. 11) and untrusted app subnet(s) 1262 (e.g., untrusted app subnet(s) 1162 of FIG. 11) of the data plane app tier 1246 and the Internet gateway 1234 contained in the data plane VCN 1218. The trusted app subnet(s) 1260 can be communicatively coupled to the service gateway 1236 contained in the data plane VCN 1218, the NAT gateway 1238 contained in the data plane VCN 1218, and DB subnet(s) 1230 contained in the data plane data tier 1250. The untrusted app subnet(s) 1262 can be communicatively coupled to the service gateway 1236 contained in the data plane VCN 1218 and DB subnet(s) 1230 contained in the data plane data tier 1250. The data plane data tier 1250 can include DB subnet(s) 1230 that can be communicatively coupled to the service gateway 1236 contained in the data plane VCN 1218.

The untrusted app subnet(s) 1262 can include primary VNICs 1264(1)-(N) that can be communicatively coupled to tenant virtual machines (VMs) 1266(1)-(N) residing within the untrusted app subnet(s) 1262. Each tenant VM 1266(1)-(N) can run code in a respective container 1267(1)-(N), and be communicatively coupled to an app subnet 1226 that can be contained in a data plane app tier 1246 that can be contained in a container egress VCN 1268. Respective secondary VNICs 1272(1)-(N) can facilitate communication between the untrusted app subnet(s) 1262 contained in the data plane VCN 1218 and the app subnet contained in the container egress VCN 1268. The container egress VCN can include a NAT gateway 1238 that can be communicatively coupled to public Internet 1254 (e.g., public Internet 954 of FIG. 9).

The Internet gateway 1234 contained in the control plane VCN 1216 and contained in the data plane VCN 1218 can be communicatively coupled to a metadata management service 1252 (e.g., the metadata management system 952 of FIG. 9) that can be communicatively coupled to public Internet 1254. Public Internet 1254 can be communicatively coupled to the NAT gateway 1238 contained in the control plane VCN 1216 and contained in the data plane VCN 1218. The service gateway 1236 contained in the control plane VCN 1216 and contained in the data plane VCN 1218 can be communicatively couple to cloud services 1256.

In some examples, the pattern illustrated by the architecture of block diagram 1200 of FIG. 12 may be considered an exception to the pattern illustrated by the architecture of block diagram 1100 of FIG. 11 and may be desirable for a customer of the IaaS provider if the IaaS provider cannot directly communicate with the customer (e.g., a disconnected region). The respective containers 1267(1)-(N) that are contained in the VMs 1266(1)-(N) for each customer can be accessed in real-time by the customer. The containers 1267(1)-(N) may be configured to make calls to respective secondary VNICs 1272(1)-(N) contained in app subnet(s) 1226 of the data plane app tier 1246 that can be contained in the container egress VCN 1268. The secondary VNICs 1272(1)-(N) can transmit the calls to the NAT gateway 1238 that may transmit the calls to public Internet 1254. In this example, the containers 1267(1)-(N) that can be accessed in real-time by the customer can be isolated from the control plane VCN 1216 and can be isolated from other entities contained in the data plane VCN 1218. The containers 1267(1)-(N) may also be isolated from resources from other customers.

In other examples, the customer can use the containers 1267(1)-(N) to call cloud services 1256. In this example, the customer may run code in the containers 1267(1)-(N) that requests a service from cloud services 1256. The containers 1267(1)-(N) can transmit this request to the secondary VNICs 1272(1)-(N) that can transmit the request to the NAT gateway that can transmit the request to public Internet 1254. Public Internet 1254 can transmit the request to LB subnet(s) 1222 contained in the control plane VCN 1216 via the Internet gateway 1234. In response to determining the request is valid, the LB subnet(s) can transmit the request to app subnet(s) 1226 that can transmit the request to cloud services 1256 via the service gateway 1236.

It should be appreciated that IaaS architectures 900, 1000, 1100, 1200 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

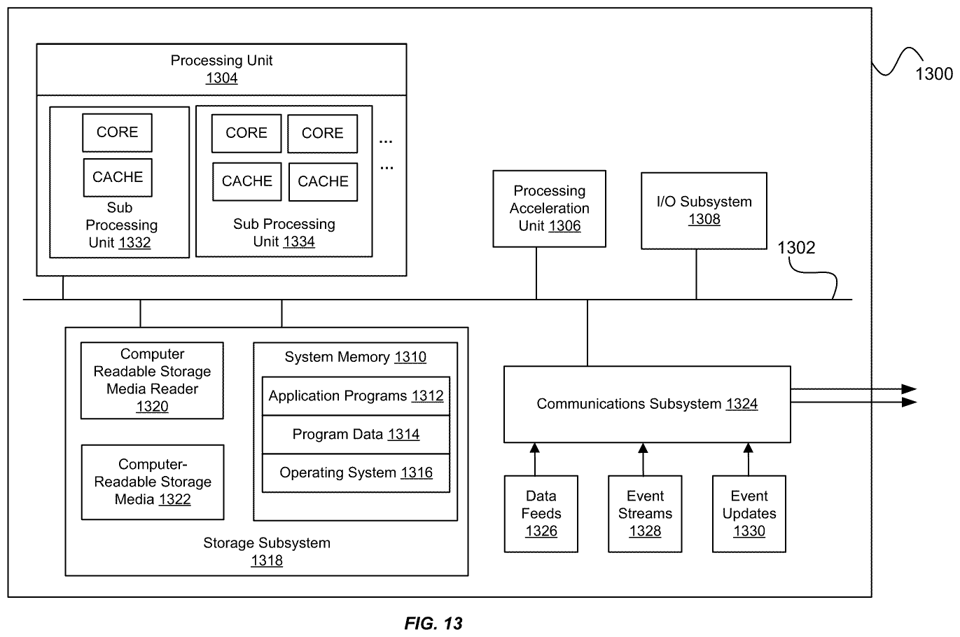

FIG. 13 illustrates an example computer system 1300, in which various embodiments may be implemented. The system 1300 may be used to implement any of the computer systems described above. As shown in the figure, computer system 1300 includes a processing unit 1304 that communicates with a number of peripheral subsystems via a bus subsystem 1302. These peripheral subsystems may include a processing acceleration unit 1306, an I/O subsystem 1308, a storage subsystem 1318 and a communications subsystem 1324. Storage subsystem 1318 includes tangible computer-readable storage media 1322 and a system memory 1310.

Bus subsystem 1302 provides a mechanism for letting the various components and subsystems of computer system 1300 communicate with each other as intended. Although bus subsystem 1302 is shown schematically as a single bus, alternative embodiments of the bus subsystem may utilize multiple buses. Bus subsystem 1302 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1304, which can be implemented as one or more integrated circuits (e.g., a conventional microprocessor or microcontroller), controls the operation of computer system 1300. One or more processors may be included in processing unit 1304. These processors may include single core or multicore processors. In certain embodiments, processing unit 1304 may be implemented as one or more independent processing units 1332 and/or 1334 with single or multicore processors included in each processing unit. In other embodiments, processing unit 1304 may also be implemented as a quad-core processing unit formed by integrating two dual-core processors into a single chip.

In various embodiments, processing unit 1304 can execute a variety of programs in response to program code and can maintain multiple concurrently executing programs or processes. At any given time, some or all of the program code to be executed can be resident in processor(s) 1304 and/or in storage subsystem 1318. Through suitable programming, processor(s) 1304 can provide various functionalities described above. Computer system 1300 may additionally include a processing acceleration unit 1306, which can include a digital signal processor (DSP), a special-purpose processor, and/or the like.

I/O subsystem 1308 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1300 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1300 may include a storage subsystem 1318 that provides a tangible non-transitory computer-readable storage medium for storing software and data constructs that provide the functionality of the embodiments described in this disclosure. The software can include programs, code modules, instructions, scripts, etc., that when executed by one or more cores or processors of processing unit 1304 provide the functionality described above. Storage subsystem 1318 may also provide a repository for storing data used in accordance with the present disclosure.

As depicted in the example in FIG. 13, storage subsystem 1318 can include various components including a system memory 1310, computer-readable storage media 1322, and a computer readable storage media reader 1320. System memory 1310 may store program instructions that are loadable and executable by processing unit 1304. System memory 1310 may also store data that is used during the execution of the instructions and/or data that is generated during the execution of the program instructions. Various different kinds of programs may be loaded into system memory 1310 including but not limited to client applications, Web browsers, mid-tier applications, relational database management systems (RDBMS), virtual machines, containers, etc.

System memory 1310 may also store an operating system 1316. Examples of operating system 1316 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1300 executes one or more virtual machines, the virtual machines along with their guest operating systems (GOSs) may be loaded into system memory 1310 and executed by one or more processors or cores of processing unit 1304.

System memory 1310 can come in different configurations depending upon the type of computer system 1300. For example, system memory 1310 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1310 may include a basic input/output system (BIOS) containing basic routines that help to transfer information between elements within computer system 1300, such as during start-up.

Computer-readable storage media 1322 may represent remote, local, fixed, and/or removable storage devices plus storage media for temporarily and/or more permanently containing, storing, computer-readable information for use by computer system 1300 including instructions executable by processing unit 1304 of computer system 1300.

Computer-readable storage media 1322 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1322 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1322 may include, but is not limited to, Zip® drives, flash memory cards, universal serial bus (USB) flash drives, secure digital (SD) cards, DVD disks, digital video tape, and the like. Computer-readable storage media 1322 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1300.

Machine-readable instructions executable by one or more processors or cores of processing unit 1304 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1324 provides an interface to other computer systems and networks. Communications subsystem 1324 serves as an interface for receiving data from and transmitting data to other systems from computer system 1300. For example, communications subsystem 1324 may enable computer system 1300 to connect to one or more devices via the Internet. In some embodiments communications subsystem 1324 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1324 can provide wired network connectivity (e.g., Ethernet) in addition to or instead of a wireless interface.

In some embodiments, communications subsystem 1324 may also receive input communication in the form of structured and/or unstructured data feeds 1326, event streams 1328, event updates 1330, and the like on behalf of one or more users who may use computer system 1300.

By way of example, communications subsystem 1324 may be configured to receive data feeds 1326 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1324 may also be configured to receive data in the form of continuous data streams, which may include event streams 1328 of real-time events and/or event updates 1330, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1324 may also be configured to output the structured and/or unstructured data feeds 1326, event streams 1328, event updates 1330, and the like to one or more databases that may be in communication with one or more streaming data source computers coupled to computer system 1300.

Computer system 1300 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1300 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. One or more computer-readable non-transitory storage media embodying software that is operable when executed to:
receive, by a software portal from a user of an external provider, a request for viewing cabling tasks associated with a set of one or more racks provisioned by a cloud service provider, wherein the request is associated with a set of specified rack metadata;
search, by the software portal, a plurality of cabling tasks for a set of cabling tasks matching the set of specified rack metadata, wherein each of the plurality of cabling tasks comprises respective cabling instructions for connecting a plurality of racks provisioned by the cloud service provider;
verify, by the software portal, whether the user has permissions to view each of the set of cabling tasks; and
responsive to verifying that the user has the permissions to view at least a subset of the set of cabling tasks, present, by the software portal to the user, the subset of the set of cabling tasks.

2. The media of claim 1, wherein the request is accompanied by a user principal associated with the user; and wherein verifying whether the user has permissions to view each of the set of cabling tasks is based at least on the user principal.

3. The media of claim 2, wherein the user principal is granted to the user based on authentication of the user by an identity provider (IdP) of the cloud service provider.

4. The media of claim 1, wherein a user account for the user of the external provider is within a tenancy managed by the cloud service provider.

5. The media of claim 4, wherein authentication of the user to the user account is performed by an identity provider (IdP) of the cloud service provider.

6. The media of claim 4, wherein a user account for a second user of the cloud service provider is within a second tenancy managed by the cloud service provider.

7. The media of claim 4, wherein a user account for a second user of a second external provider is within a same tenancy managed by the cloud service provider.

8. The media of claim 4, wherein an access policy that provides permissions for accessing cabling tasks is scoped to user accounts within a specified tenancy.

9. The media of claim 1, wherein the software portal comprises a front end and a back end, and wherein receiving the request is performed by the front end of the software portal; and wherein searching the plurality of cabling tasks for the set of cabling tasks and verifying whether the user has the permissions are performed by the back end of the software portal.

10. The media of claim 9, wherein the front end and the back end are within different virtual cloud networks of a same tenancy.

11. The media of claim 1, wherein the software is further operable when executed to:
receive, by the software portal from the user of the external provider, a second request for a set of one or more cutsheets associated with a specified rack;
verify, by the software portal, whether the user has permissions to view each of the set of cutsheets;
responsive to verifying that the user has the permissions to view at least a subset of the set of cutsheets, present, by the software portal to the user, the subset of the set of cutsheets.

12. The media of claim 11, the set of cabling tasks and the set of cutsheets are obtained from different data sources.

13. The media of claim 1, wherein the software is further operable when executed to:
receive, by the software portal from the user of the external provider, a second request to update a status corresponding to a first cabling task of the set of cabling tasks;
based on the second request, update the status corresponding to the first cabling task.

14. The media of claim 1, wherein the plurality of cabling tasks comprise at least one of:
wiring tasks generated by one or more users of the cloud service provider; and
validating tasks generated based on validation activity executed by a rack deployment and validation service.

15. The media of claim 14, wherein execution of the validation activity is triggered responsive to detecting resolution of a wiring task of the plurality of cabling tasks.

16. The media of claim 1, wherein the software portal comprises a graphical user interface (GUI), wherein the GUI is configured to display an overview the subset of the set of cabling tasks, wherein the GUI is further configured to display details of each of the subset of the set of cabling tasks upon receiving a user selection of each of the subset of the set of cabling tasks, and wherein the GUI is operable for the user of the external provider to update a status associated with each of the subset of the set of cabling tasks.

17. The media of claim 1, wherein the external provider comprises a low voltage vendor (LVV).

18. The media of claim 1, wherein searching the plurality of cabling tasks for the set of cabling tasks comprises:
identifying respective rack metadata associated with each of the plurality of cabling tasks;
determining whether the respective rack metadata matches the set of specified rack metadata; and
identifying the set of cabling tasks associated with the respective rack metadata that matches the set of specified rack metadata.

19. A system comprising: one or more processors; and a non-transitory memory coupled to the processors comprising instructions, when executed using the processors, cause the processors to execute:
receiving, by a software portal from a user of an external provider, a request for viewing cabling tasks associated with a set of one or more racks provisioned by a cloud service provider, wherein the request is associated with a set of specified rack metadata;
searching, by the software portal, a plurality of cabling tasks for a set of cabling tasks matching the set of specified rack metadata, wherein each of the plurality of cabling tasks comprises respective cabling instructions for connecting a plurality of racks provisioned by the cloud service provider;
verifying, by the software portal, whether the user has permissions to view each of the set of cabling tasks; and
responsive to verifying that the user has the permissions to view at least a subset of the set of cabling tasks, presenting, by the software portal to the user, the subset of the set of cabling tasks.

20. A method comprising, by one or more computing systems:
receiving, by a software portal from a user of an external provider, a request for viewing cabling tasks associated with a set of one or more racks provisioned by a cloud service provider, wherein the request is associated with a set of specified rack metadata;
searching, by the software portal, a plurality of cabling tasks for a set of cabling tasks matching the set of specified rack metadata, wherein each of the plurality of cabling tasks comprises respective cabling instructions for connecting a plurality of racks provisioned by the cloud service provider;
verifying, by the software portal, whether the user has permissions to view each of the set of cabling tasks; and
responsive to verifying that the user has the permissions to view at least a subset of the set of cabling tasks, presenting, by the software portal to the user, the subset of the set of cabling tasks.
